(19) United States
(12) Patent Application Publication
(10) Pub. No.: US 2004/0137805 A1
(43) Pub. Date: Jul. 15, 2004

(54) Method and a system for detecting bus width, an electronic device, and a peripheral device

(75) Inventors: Kimmo Mylly, Julkujarvi (FI); Matti Floman, Kangasala (FI)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/723,261

(22) Filed: Nov. 26, 2003

(30) Foreign Application Priority Data
Nov. 29, 2002 (FI) FI 20022113

(51) Int. Cl. H01R 9/22

(52) U.S. Cl. 439/894

(57) ABSTRACT

The present invention relates to a method for detecting the bus width of a peripheral device (12) connected to an electronic device (1). At least one bus width from a defined set of bus widths is available in the peripheral device (12). In the method, for detecting the bus widths available for the peripheral device (12), one or more indicators (17, DAT3) formed in the peripheral device (12) are used, which indirectly indicate which one or ones of said set of bus widths are available in the peripheral device (12). The invention also relates to a system, in which the method is applied, as well as an electronic device (1) and a peripheral device (12).

### CROSS-REFERENCE TO RELATED APPLICATIONS

This application claims priority under 35 USC §119 to Finnish Patent Application No.20022113 filed on Nov. 29, 2002.

### FIELD OF THE INVENTION

The present invention relates to a method for detecting the bus width of a peripheral device connected to an electronic device, which peripheral device has at least one bus width available from a defined set of bus widths. The invention also relates to a system comprising an electronic device, an auxiliary device which can be connected to the electronic device and in which at least one bus width from a defined set of bus widths is arranged to be used, and which system comprises a bus width detector for detecting at least one bus width available for used in the peripheral device connected to the electronic device. The invention also relates to an electronic device provided with a bus width detector for detecting the bus width of a peripheral device connected to the electronic device, in which peripheral device at least one bus width is arranged to be used from a defined set of bus widths. The invention also relates to a peripheral device which can be connected to an electronic device provided with a bus width detector for detecting the bus width of the peripheral device connected to the electronic device, and in which peripheral device at least one bus width is arranged to be used from a defined set of bus widths.

### BACKGROUND OF THE INVENTION

Electronic devices are known, to which it is possible to connect various peripheral devices, such as cards (interface cards, expansion cards), by which it is possible to change the facilities of the electronic device. For example, such a card can be used to provide a memory expansion for an electronic device, such as a computer, a wireless communication device, a personal digital assistant, etc. The electronic device is thus equipped with a peripheral device connection, such as a card connection, in which the peripheral device is placed. Via the peripheral device connection, it is possible to supply the necessary operating voltages, control and data signals to the card. In a corresponding manner, information can be transmitted from the card to the electronic device via this peripheral device connection. The peripheral device connection typically comprises a control bus, an address bus and/or a data bus. The control bus is used for the transmission of control information between the electronic device and the card. The address bus is used for the transmission of addresses to the card. The data bus, in turn, is intended for the transmission of information between the electronic device and the card. However, arrangements have been developed, in which one or several of said buses are combined at least partly. For example, some of the address data can be transmitted via the control bus. An example of such a card is the memory card complying with the MultiMediaCard™ specifications. It is also possible that some of the address data can be transmitted via the data bus.

A problem in the systems of prior art is, for example, the fact that the same bus widths are not necessarily used in all cards, wherein the electronic device should, in each case, be capable of determining the bus width of the card connected to the electronic device, for example the width of the data bus. If the bus width is assumed or detected to be incorrect in the electronic device, this will cause error situations and the card can probably not be used at all. For example, the memory card complying with so-called SD Memory Card specifications (v. 1.01) comprises a data bus, in which it is possible to select either a 1-bit data bus or a 4-bit data bus. To maintain compatibility of such cards complying with newer specifications with the earlier versions, the card initialization steps are taken by using the data bus width of 1 bit. Thus, when starting the card, the card and the device to which the card is connected communicate on the 1-bit data bus. After the electronic device has determined the bus widths supported by the card, the electronic device can control the card to use another bus width which can be selected, for example a 4-bit bus. If the card or the electronic device does not support other bus widths than the 1-bit data bus, the operation is continued by using the 1-bit data bus width. The bus widths can be determined, for example, in such a way that the electronic device transmits a card initialization command complying with the SD specifications (ACMD 41). If the card responds to this command, it can be determined that the card is a card complying with said specifications. In other cases, it is possible to transmit, for example, an initialization command complying with the MultiMediaCard™ specifications (CMD 1), and if the card responds to this command, it can be determined that the card is a card complying with the MultiMediaCard™ specifications.

International patent application WO 02/15020 discloses an arrangement, in which two or more memory cards can be connected to an electronic device. Thus, information about the data bus width supported by the card is stored in each memory card. The electronic device can thus read this information and select the data bus width to be one supported by the card in question. One drawback in such an arrangement is that the storage of the bus width data requires memory space (registers) on the card.

### SUMMARY OF THE INVENTION

It is an aim of the present invention to provide an improved method and a system, in which the determination of the bus widths supported by the card does not require that the bus width data is stored on the card. The invention is based on the idea that for determining the bus width, another indication formed on the card is used, on the basis of which the bus width can be determined. One advantageous example of such an indication is the information, stored on the card, about the standard and/or standard version supported by the card. To put it more precisely, the method according to the present invention is primarily characterized in that for detecting the bus widths available on the card, one or more indicators formed on the card are used, which indirectly indicate which one or ones of said set of bus widths are available on the card. The system according to the present invention is primarily characterized in that the card is provided with one or more indicators which are arranged to indirectly indicate, which one or ones of said set of bus widths are available on the card. The electronic device according to the present invention is primarily characterized in that the detector also comprises means for determining the value of one or more indicators formed on the card, which indicator is arranged to indirectly indicate which one or ones of said set of bus widths are available on the card. The card according to the present invention is primarily characterized in that the card is provided with one or more indicators which are arranged to indirectly indicate, which one or ones of said set of bus widths are available on the card.

Considerable advantages are achieved by the present invention. By means of the arrangement according to the invention, the bus widths supported by the card can be determined in the electronic device without the need to store this information as such on the card, wherein the register capacity of the card is saved for another purpose. Furthermore, the detection is also faster than the use of different initialization commands in the detection of the bus width.

### DESCRIPTION OF THE DRAWINGS

In the following, the invention will be described in more detail with reference to the appended drawings, in which

FIG. 1 shows an electronic device and a card according to a first advantageous embodiment of the invention in a simplified block diagram,

FIG. 2 illustrates the signalling between the electronic device and the card in connection with the method according to the first advantageous embodiment of the invention,

FIG. 3 shows an electronic device and a card according to a second advantageous embodiment of the invention in a reduced block chart, and

FIG. 4 illustrates the signalling between the electronic device and the card in connection with the method according to the second advantageous embodiment of the invention.

### DETAILED DESCRIPTION OF THE INVENTION

In the following description of an advantageous embodiment of the invention, the electronic device will be exemplified with a wireless terminal 1, but it should be evident that the invention is not limited to be used in such terminals only. Furthermore, the peripheral device will be exemplified with a card-like peripheral device, wherein the peripheral device connection of the peripheral device 1 will be called a card connection below. However, the invention is not limited solely to card-like peripheral devices, but the present invention can also be applied in connection with other peripheral devices in which one or more buses are used for connecting it to the electronic device 1. The terminal 1 comprises a processor 2, a memory 3, which may also comprise several different memory blocks, such as a read only memory (ROM) and a random access memory (RAM). Furthermore, a part of the memory can be a non-volatile memory, such as an EEPROM memory, in a way known as such. Furthermore, the terminal preferably comprises a display 4, a keypad 5, and audio means, such as an earpiece and/or a speaker 6 and a microphone 7. Preferably, the terminal 1 also comprises communication means, such as a transmitter 9 and a receiver 8, for data transmission between the terminal 1 and a communication network 10. These communication means 8, 9 are preferably intended for wireless communication, wherein the communication network 10 comprises a wireless communication network, such as a mobile communication network, a wireless local area network, or the like. The terminal also comprises a card connection 11 for connecting one or more cards 12 to the terminal 1.

In the card connection 11, there is preferably a card controller 13 for controlling the functions necessary for using the card 12 connected to the card connection. Furthermore, the card connection is provided with the necessary buses 14a, 14b, by means of which e.g. commands and data can be transferred between the card 12 and the terminal 1. If more than one card can be simultaneously connected to the card connection 11, the card connection 11 is provided with several connectors (not shown), to which the buses 14a, 14b are coupled.

In this advantageous embodiment, the card 12 is implemented in such a way that several widths of the data bus 14a can be used in connection with it. In this context, the bus widths of 1, 4 and 8 bits are used as non-restrictive examples of the bus widths. However, it will be obvious that the invention is not limited solely to the bus widths mentioned here. Furthermore, it should be mentioned in this context that the invention can also be applied in connection with other buses than the data bus. For example, in connection with cards provided with an address bus, various alternative widths can be set for the address bus, if necessary, of which one is selected for use each time. Also, the control bus 14b can, in some cases, be implemented to have a selectable width according to the invention.

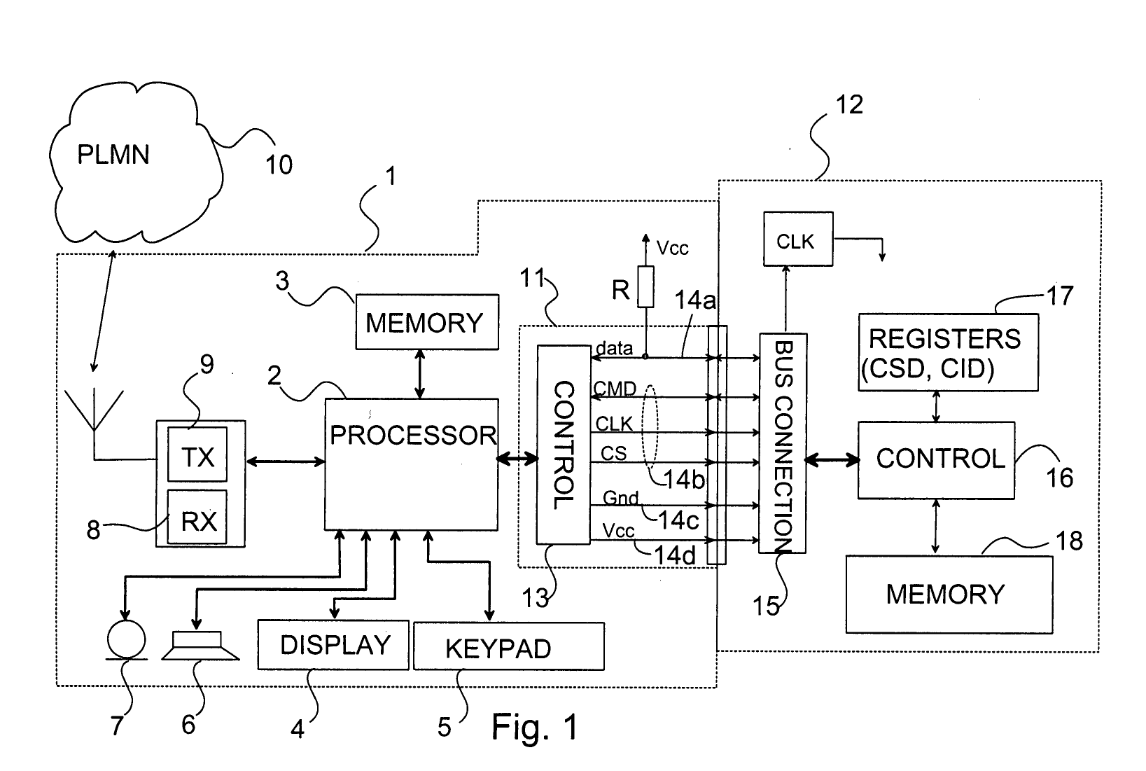

In various applications, the card 12 to be connected to the terminal 1 may be very different, and the present invention is not limited to any specific card. Some non-restrictive examples to be mentioned of such cards 13 include memory cards, such as a memory card complying with the specifications of a MultiMediaCard or a memory card complying with the specifications of an SD Memory Card, communication cards, such as cards comprising mobile communication functions, etc. In the use of the various card types, the terminal card connection 11 may vary, but a person skilled in the art will be able to apply the invention in also other types of cards and card connections on the basis of the following example applications. In the system according to an advantageous embodiment of the invention, shown in FIG. 1, the card is a memory card complying with the MultiMediaCard specifications, and the data transfer between the card 12 and the card controller 13 of the terminal 1 takes place in serial format according to the MultiMediaCard specifications. In this case, the card connection 11 is preferably provided with at least a data bus 14a and a control bus 14b, as well as one or more ground lines 14c (Gnd) set to the zero potential, and one or more operating voltage lines 14d (Vcc). The control bus 14b preferably comprises a command line CMD, a clock line CLK, and a chip select line CS. Pull-up resistances R are preferably coupled to the lines of the data bus 14a, of which only one resistance is shown in FIG. 1 for clarity.

FIG. 1 also shows the internal structure of one such card 12 in a simplified block diagram. The card 12 comprises a bus connection block 15, via which the buses 14a, 14b are connected to the card 12. The card is preferably also provided with a control unit 16 for controlling the functions of the card 12. Preferably, the card 12 also comprises internal registers 17 for storing some data. Since the card 12 used here as an example is a memory card, the card 12 is also provided with a memory 18 which can be a read only memory and/or a random access memory. The memory 18 may comprise one or more memory types, such as a dynamic memory (DRAM), a static memory (SRAM), or a non-volatile memory (e.g. EEPROM, Flash). The memory 18 may also be implemented wholly or partly as a magnetic and/or optic memory, of which non-restrictive examples include a fixed disk, a CD-ROM, and a digital versatile disk. Furthermore, the card 12 preferably comprises a clock circuit for generating clock signals required in the operation of the different functional blocks of the card 12 in a way known as such.

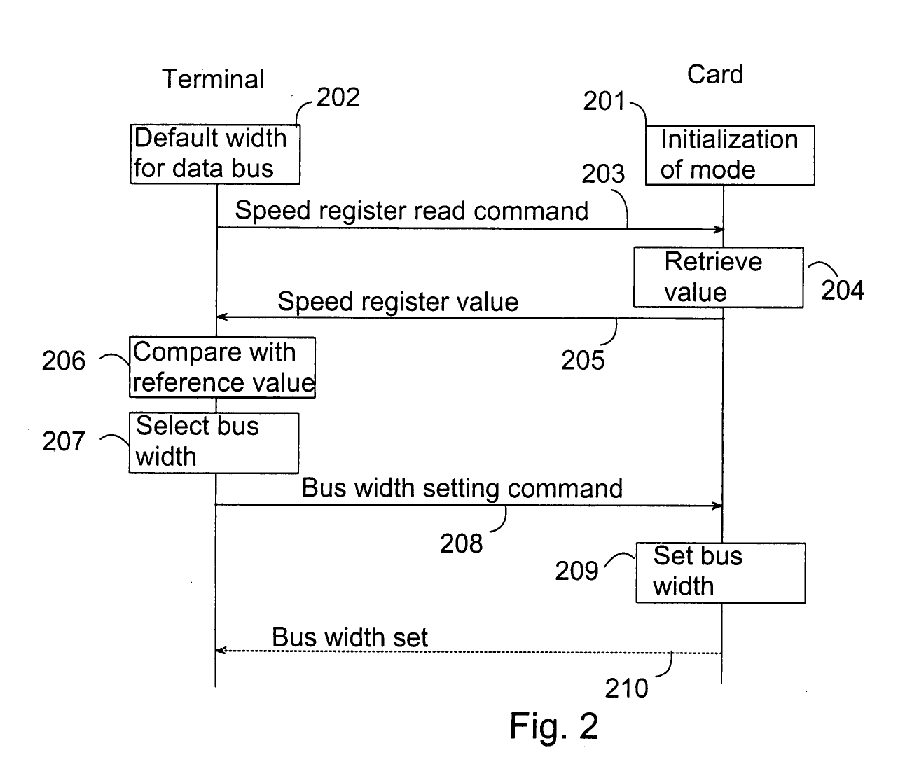

In the method according to a first advantageous embodiment of the invention, the bus width of the card is preferably detected in the following way. The procedure of the method is also shown as a signalling chart in FIG. 2. The card 12 comprises some registers 17 containing stored information about the properties of the card 12. One such register is a speed register SP containing stored information about the maximum clock frequency supported by the card. After the operating voltages have been turned on, the card 12 performs initialization of the operating mode (block 201 in FIG. 2), after which the card 12 is in a given mode. At this stage, the width of the data bus 14a is set in the terminal 1 to a default value, which in this advantageous embodiment is the 1-bit data bus (block 202). After this, the controller 13 transmits a command to read the speed register SP on the command line CMD to the card (arrow 203). The card 12 receives the command via the bus connection 15, from which the command is transmitted to the controller 16 on the card. The controller 16 interprets the command and retrieves the value contained in the speed register SP (block 204) and transmits it via the bus connection 15 to the terminal 1 (arrow 205). In the terminal 1, the controller 13 interprets the received data and compares it with determined reference values (block 206). Let us assume here that the alternatives are 20 MHz, 25 MHz and 50 MHz. Furthermore, let us assume that if the maximum speed complies with the first alternative (20 MHz), the data bus width of the card is 1 bit. If the maximum speed complies with the second alternative (25 MHz) or the third alternative (50 MHz), the data bus width can be set to either 1, 4 or 8 bits on the card 12. Thus, if the speed register value is the first alternative, the operation can, in this embodiment, be continued without changing the bus width, because the default value is the 1-bit bus. However, if the speed register value is the second or the third alternative, the bus width can be selected to one of the alternatives 1, 4 or 8 bits (block 207). Thus, when faster data transmission is desired, the bus with of 4 bits or 8 bits is selected for the data bus. To implement this, the controller 13 transmits a bus width set command (e.g. Switch) to the card 12, whereby the selected bus width is set as the new bus width, that is, 4 or 8 bits in this example (arrow 208). For each bus width, it is possible to form a separate command, or the bus width set command is provided with information about the bus width to be set on the card. On the card, the received command is examined and the bus width is set to comply with the bus width indicated in the command (block 209). After the bus width has been changed to the desired width, the card preferably indicates this in a suitable manner, for example by transmitting an acknowledgement command or the like (arrow 210), or the terminal 1 assumes that the bus width has been set after a given delay, wherein the card 12 does not need to separately inform about the setting of the bus width.

After the bus width has been set, the selected bus width can also be used in the terminal. For example, if the width of the data bus 14a has been changed to 4 bits, information can be transmitted in arrays of four bits between the terminal 1 and the card 12. After the change of the bus width, the card 12 and/or the terminal 1 may need to make internal changes in the data transmitted on the data bus 14a, such as to convert 4-bit data into 1-bit or 8-bit data for further processing. However, this is prior art known by anyone skilled in the art, wherein it is not necessary to describe it in more detail in this context. It should also be mentioned that in some applications, it is not necessary to write data on all the lines of the data bus simultaneously, but the writing on the different lines may take place within given timing tolerances, for example in sequential order.

The above-mentioned values of the speed register, 20 MHz, 25 MHz and 50 MHz, are only some examples. For example, an ordinary card complying with the MultiMediaCard™ specifications supports only one bus width (1 bit), and the maximum clock frequency is 20 MHz. There are also faster cards under development (HSMMC, High Speed Multi-MediaCard™), in which the maximum clock frequency may be 25 MHz or 50 MHz. In both of these cases, the data bus width may be 1, 4 or 8 bits.

In connection with the first advantageous embodiment of the invention, it is also possible to use another register than said speed register to determine the bus widths supported by the card 12. For example, information about the card version may be stored on the card 12, wherein the terminal 1 comprises information about the supported bus widths corresponding to the different versions. In this alternative, the terminal 1 reads the value of the register containing such version information from the card 12. In a card complying with the MultiMediaCard™ specifications, the version may be, at the date of filing of the present application, for example 3.1 or 3.2 (or smaller). In cards 12 supporting fast data transmission (and bus widths greater than one bit), the version data is preferably greater than said 3.2. In general, if there are various bus width alternatives for the card, the version data stored on the card can be used to find out the bus width supported by the card. Thus, the terminal 1 comprises stored information about these versions and the bus widths supported by each version. However, also in this alternative, information about the bus width does not need to be stored on the card.

Yet another alternative for the above-presented registers is that information about the card type is stored on the card 12. Such type data may be, for example, information about whether it is a fast card or a slow card. A slow card (e.g. maximum clock frequency 20 MHz) will only support one bus width. In a corresponding manner, a fast card (maximum clock frequency e.g. greater than 20 MHz) will support several bus widths. Other type data may include information about the operating voltage (low/high voltage) or information about the physical size of the card (full-size/half card). In this embodiment, the necessary quantity of bits of e.g. the CSD register can be used in the storage of the type data.

If necessary, the above-presented different alternatives can be combined, if the data of one register does not identify the bus width supported by the card 12 with sufficient certainty. In this case, the terminal 1 comprises information about the compliance of the different combinations and bus widths.

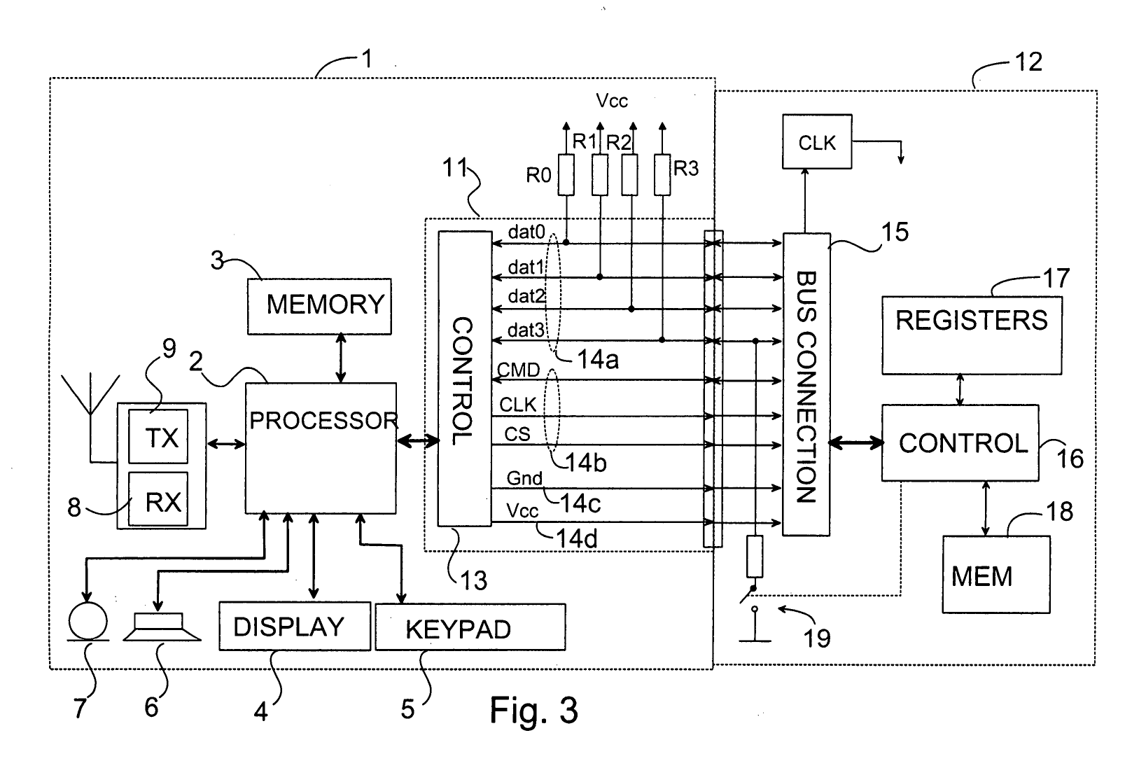

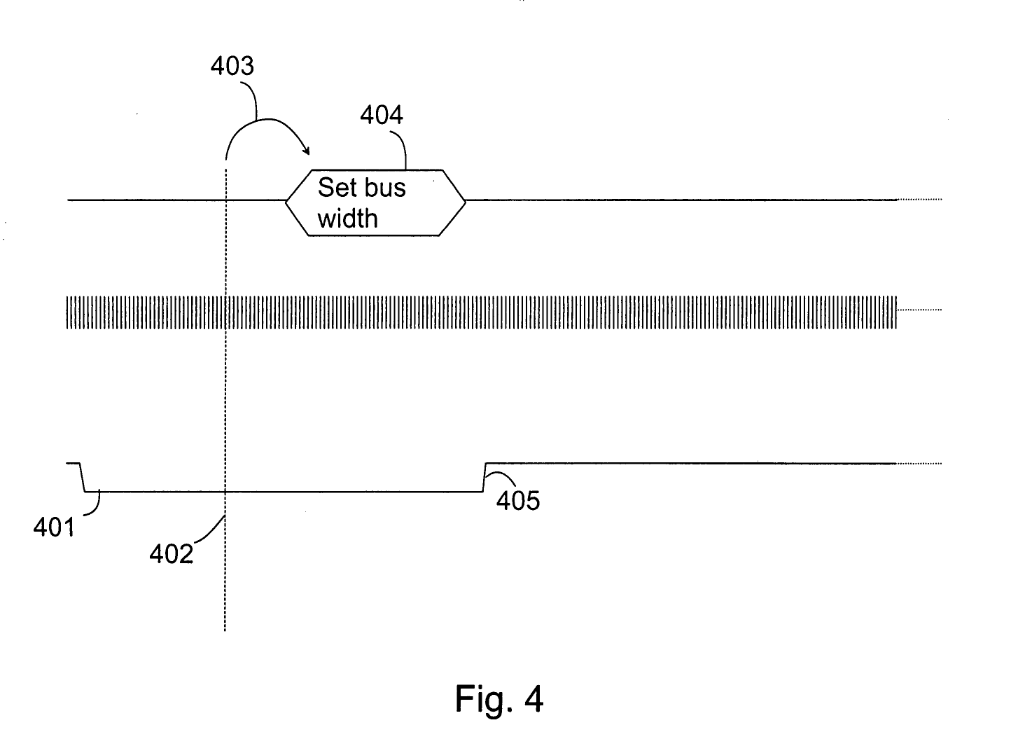

FIG. 3 shows the coupling of the electronic device 1 according to another advantageous embodiment of the invention and a card 12 in a simplified manner. In a corresponding manner, FIG. 4 shows an advantageous example of the signalling to be used in the method according to this embodiment in connection with the determination of the bus width. In this embodiment, the card 12 indicates the bus width supported by it via one or several lines. In this non-restrictive example, a fourth data bus DAT3 is used, but also other lines can be used. Let us assume that either a default bus width or another bus width can be selected. Thus, in the method according to this embodiment, the bus width of the card is detected preferably in the following way. At the boot step, in connection with the initialization of a mode, or substantially after the same, the card 12 sets the state of the fourth data bus DAT3 in a first logical value, for example in the 0 state (401), if the card 12 supports also other bus widths than the default bus width. This can be provided e.g. in such a way that the controller 16 closes the switch 19, wherein the fourth data bus DAT3 is coupled to the ground potential. The state of the fourth data bus is thus in the logical 0 state. The terminal 1 reads the state of this fourth data bus DAT3 (402), and if it is in said logical 0 state, the data bus width can be set in the terminal 1 to another value than the default bus width (403). In a corresponding manner, if the card 12 does not set the state of the fourth data bus DAT3 to this first logical value, it is assumed that the card 12 only supports the default bus width. The pull-up resistance R3 of the data line DAT3 is used to provide that if such function of indicating the support bus widths is not implemented on the card 12, the state of the data line DAT3 in the terminal 1 is in the logical 1 state, which is consequently interpreted in this case as the state corresponding to the default bus width.

After the terminal 1 has received information about the bus widths supported by the card 12, a command to set the bus width is transmitted to the card (404), if several different bus widths are available in the card 12. After the card 12 has received this command, the controller 16 of the card 12 opens the switch 19, after which the fourth data bus is available for data transmission (405).

Consequently, the above-described example comprises two alternatives for the bus widths supported by the card. If there are more alternatives, several lines can be used, such as a second and a third data line, wherein the combination of the states of these lines indicates the bus widths supported by the card 12.

Although only the 1-bit bus or the set of three alternatives (1/4/8 bits) was presented above as the bus width alternatives supported by the card 12, the invention can also be applied in the case of other bus widths and several different alternatives.

The above-mentioned functions for determining the bus width can be implemented primarily by software preferably in the controller 13, the processor 2, or both. However, it will be obvious that also other implementation alternatives are possible to apply the above-mentioned methods in the electronic device 1.

The present invention is not limited solely to the above-presented embodiments, but it can be modified within the scope of the appended claims.

1. A method for detecting the bus width of a peripheral device connected to an electronic device, wherein at least one bus width from a determined set of bus widths is available in the peripheral device, wherein for detecting the bus widths available in the peripheral device, one or more indicators formed in the peripheral device are used, which indirectly indicate which one or ones of said set of bus widths are available in the peripheral device.

2. The method according to claim 1, wherein reference data is stored in the electronic device about at least one bus width available in the peripheral device and corresponding to said indicator value.

3. The method according to claim 2, wherein said indicator used is information stored in the peripheral device and indicating indirectly, which one or ones of said set of bus widths are available in the peripheral device.

4. The method according to claim 3, wherein said data stored in the peripheral device is information about the maximum clock frequency available in the peripheral device.

5. The method according to claim 3, wherein at least a fast peripheral device and a slow peripheral device are defined, wherein said information stored in the peripheral device is information about whether the peripheral device is fast or slow.

6. The method according to claim 3, wherein said data stored in the peripheral device is information about the version of the peripheral device.

7. The method according to claim 2, comprising performing at least the following steps:
a request step, in which a request is transmitted from the electronic device to the peripheral device to transmit the value of said indicator to the electronic device,
a reply step, in which said indicator value is transmitted from the peripheral device to the electronic device,
an identification step, in which said indicator value is compared with at least one reference value stored in the electronic device,
a selection step for selecting one bus width available in the peripheral device, and
a setting step for setting the selected bus width for the peripheral device.

8. The method according to claim 1, wherein at least one connection line is formed between the electronic device and the peripheral device, and using at least one said connection line as said indicator.

9. The method according to claim 8, comprising performing at least the following steps:
an initialization step, in which the value of said at least one connection line is set to correspond indirectly to the bus widths available in the peripheral device,
a detection step, in which the electronic device examines the state of said at least one connection line and compares the state of said connection line with at least one reference value stored in the electronic device,
a selection step for selecting one bus width available in the peripheral device, and
a setting step for setting the selected bus width for the peripheral device.

10. A system comprising an electronic device, a peripheral device which can be connected to the electronic device and in which at least one bus width is arranged to be used from a defined set of bus widths, and which system comprises a bus width detector for detecting at least one bus width available in the peripheral device connected to the electronic device, wherein the peripheral device is provided with one or more indicators, which are indirectly arranged to indicate which one or ones from said set of bus widths are available in the peripheral device.

11. An electronic device comprising a bus width detector for detecting the bus width of a peripheral device connected to the electronic device, in which peripheral device at least one bus width is arranged to be used from a defined set of bus widths, the detector also comprising means for determining the value of one or more indicators formed in the peripheral device, which indicator is arranged to indirectly indicate which one or ones of said set of bus widths are available in the peripheral device.

12. The electronic device according to claim 11, wherein reference data is stored in the electronic device about at least one bus width available in the peripheral device and corresponding to said indicator value.

13. The electronic device according to claim 12, wherein said indicator arranged to be used is information stored in the peripheral device and indicating indirectly, which one or ones of said set of bus widths are available in the peripheral device.

14. The electronic device according to claim 13, wherein at least one connection line is formed between the electronic device and the peripheral device, and that said indicator arranged to be used is at least one said connection line.

15. The electronic device according to claim 14, said detector comprising means for examining the value of said connection line.

16. A peripheral device which can be connected to an electronic device comprising a bus width detector for detecting the bus width of the peripheral device connected to the electronic device, and in which peripheral device at least one bus width from a defined set of bus widths is arranged to be used, wherein the peripheral device is provided with one or more indicators which are arranged to indirectly indicate which one or ones of said set of bus widths are available in the peripheral device.

17. The peripheral device according to claim 16, wherein information about the maximum clock frequency available in the peripheral device is stored in the peripheral device.

18. The peripheral device according to claim 16, wherein at least a fast peripheral device and a slow peripheral device have been defined, wherein information about whether the peripheral device is fast or slow is stored in the peripheral device.

19. The peripheral device according to claim 16, wherein information about version of the peripheral device is stored in the peripheral device.

20. The peripheral device according to claim 16, comprising at least one connection line, and means for setting said connection line in a value which indirectly corresponds to the bus widths available in the peripheral device.

21. A memory card which can be connected to an electronic device comprising a bus width detector for detecting the bus width of the memory card connected to the electronic device, and in which memory card at least one bus width from a defined set of bus widths is arranged to be used, wherein the memory card is provided with one or more indicators which are arranged to indirectly indicate which one or ones of said set of bus widths are available in the memory card.
